(19) United States
(12) Patent Application Publication
(10) Pub. No.: US 2019/0168860 A1
(43) Pub. Date: Jun. 6, 2019

(54) Aeroplane With Configuration Changing In Flight

(71) Applicant: AIRBUS SAS, Blagnac (FR)

(72) Inventors: Nicolaas Peter Esteie, Tournefeuille (FR); Diego Alonso Tabares, Toulouse (FR)

(73) Assignee: AIRBUS SAS, Blagnac (FR)

(21) Appl. No.: 16/190,686

(22) Filed: Nov. 14, 2018

(30) Foreign Application Priority Data
Dec. 1, 2017 (FR) 17 61518

(51) Int. Cl. B64C 5/18; B64C 5/02; B64C 17/02

(52) U.S. Cl. CPC B64C 5/18; B64C 17/02; B64C 5/02

(57) ABSTRACT

The aeroplane includes at least a fuselage, two wings, a rear tail unit including a horizontal tail provided with two tail ends, and at least two engines arranged on the fuselage on either side of a vertical plane of symmetry of the aeroplane. The aeroplane has a longitudinal axis. The engines are mounted so as to be able to be displaced, at least in flight, on the fuselage, substantially parallel to the longitudinal axis, and the tail ends are mounted so as to be able to be pivoted, at least in flight, relative to the horizontal tail. The aeroplane thus has a configuration that changes in flight.

### FIELD OF THE INVENTION

The present invention relates to an aeroplane with aerodynamic configuration changing in flight.

The present invention applies to an aeroplane, in particular a transport aeroplane, which comprises in particular a fuselage, two wings, at least two engines arranged on either side of a vertical plane of symmetry of the aeroplane, and horizontal and vertical rear tails implementing the usual functions of stability and of control of the attitude and of the trajectory of the aeroplane.

### BACKGROUND OF THE INVENTION

It is known that, in general, the horizontal tail of an aeroplane comprises a fixed part and a mobile part representing an elevator, and the vertical tail comprises a fixed part and a mobile part representing a rudder.

Such a standard architecture of an aeroplane with rear (horizontal and vertical) tails, presents drawbacks. In particular:
when the aeroplane is in cruising flight, the rear vertical tail contributes little to the aerodynamics of the aeroplane and adds weight and drag for no aerodynamic, economic or safety advantage. This rear vertical tail is used, primarily, during the take-off and landing phases, when rapid changes in direction can occur. It is also very important when an engine undergoes shut down during take-off. The rudder is then activated by the pilot to act against the thrust imbalance. Consequently, the rear vertical tail is used only for short periods of time during the flight, although it represents a significant surface area, generally of the order of 10% of the wing surface area; and
the purpose of the rear horizontal tail is to counteract both the natural pitch moment of the wings, and the position of the centre of gravity located forward of the centre of lift of the wings. The rear horizontal plane exerts a downward force to keep the aeroplane stable and in balance during a flight. This results in a loss of efficiency, both aerodynamic and economic. The rear horizontal tail does not participate in the lift of the aeroplane. On the contrary, it degrades it by approximately 5%, while representing 15% to 20% of the wing surface area.

The configuration of such an aeroplane, which is fixed, is not therefore optimal in all the flight phases.

### BRIEF SUMMARY OF THE INVENTION

In the context of the present invention, the configuration of the aeroplane depends in particular on the characteristics of the rear tail unit and on the position of the centre of gravity of the aeroplane.

An aspect of the present invention may remedy this drawback. To do this, it relates to an aeroplane, in particular a transport aeroplane, which comprises at least a fuselage, two wings, a rear tail unit comprising a horizontal tail provided with two tail ends, and at least two engines arranged on the fuselage on either side of a vertical plane of symmetry of the aeroplane, said aeroplane having a longitudinal axis.

According to an embodiment of the invention, said engines are mounted so as to be able to be displaced, at least in flight, on said fuselage, substantially parallel to the longitudinal axis, and said tail ends are mounted so as to be able to be pivoted, at least in flight, relative to said horizontal tail.

Thus, by virtue of the capacity both to displace the engines of the aeroplane and to pivot the tail ends, during a flight, there is a possibility of changing the configuration of the aeroplane in flight. As specified below, this makes it possible in particular to adapt the configuration of the aeroplane to the current flight phase, in order to exploit the various elements of the rear tail unit (and do so in differentiated ways) during the various flight phases.

Advantageously, said aeroplane having a centre of gravity and a centre of lift (of the wings), comprises at least one displacement mechanism capable of being controlled and configured to be able to bring each of said engines, at least in flight, alternately into one or other of the following two stable positions, on the fuselage:
a so-called forward position, in which the centre of gravity of the aeroplane is situated towards the front of the aeroplane relative to its centre of lift; and
a so-called aft position, positioned towards the rear of the aeroplane relative to said forward position and in which the centre of gravity of the aeroplane is situated towards the rear of the aeroplane relative to its centre of lift.

Furthermore, advantageously, the aeroplane also comprises at least one pivoting mechanism capable of being controlled and configured to be able to bring each of the two tail ends, at least in flight, alternately into one or other of the following two stable positions:
a first, so-called folded position, in which the two tail ends are arranged substantially orthogonally to a general plane of said horizontal tail so as to form a vertical tail; and
a second, so-called deployed position, in which the two tail ends are arranged substantially in the general plane of said horizontal tail so as to be able to form, with the horizontal tail, an augmented horizontal tail surface.

In the context of the present invention, the displacement and pivoting mechanisms can be produced in different ways. Advantageously, the displacement mechanism can comprise a sliding system or an articulation system.

Moreover, advantageously, the aeroplane further comprises mobile control surfaces configured to act on the yaw of the aeroplane.

The present invention applies equally to aeroplanes whose engines are turbojet engines or turbopropeller engines, and to aeroplanes whose engines are propfan or open rotor engines.

The present invention relates also to a method for modifying a configuration of an aeroplane in flight, said aeroplane comprising at least a fuselage, two wings, a rear tail unit comprising a horizontal tail provided with two tail ends, and at least two engines arranged on the fuselage on either side of a vertical plane of symmetry of the aeroplane, said engines being mounted so as to able to be displaced on said fuselage, substantially parallel to a longitudinal axis of the aeroplane, and said tail ends being mounted so as to be able to be pivoted relative to said horizontal tail.

According to an aspect of the invention, said method for modifying the configuration of the aeroplane comprises:
at least a first step consisting in bringing said engines into a so-called forward position and in bringing said tail ends into a so-called folded position in which the tail ends are arranged substantially orthogonally to a general plane of said horizontal tail; and
at least a second step consisting in bringing said engines into a so-called aft position displaced towards the rear of the aeroplane relative to said forward position and in bringing said tail ends into a so-called deployed position in which the tail ends are arranged substantially in the general plane of said horizontal tail,
   said first and second steps being implemented at least during a flight of the aeroplane.

Advantageously, said first step is implemented, at least, during a take-off phase of the aeroplane and/or during a landing phase of the aeroplane, and said second step is implemented, at least, during a cruising flight phase of the aeroplane.

Thus:
during the take-off and landing phases, the configuration of the aeroplane is conventional, with the tail ends arranged vertically at the ends of the horizontal tail. Furthermore, since the engines are brought into the forward position, the centre of gravity of the aeroplane is situated forward of the centre of lift, and the (rear) horizontal tail exerts a downward force to keep all of the aeroplane in balance;
during the cruising flight phase or phases, the engines are displaced towards the rear, in the aft position, which causes a displacement to the rear of the centre of gravity, which is then to the rear of the main centre of lift of the aeroplane. The horizontal tail and the tail ends become a lift surface and participate in the lift of the aeroplane. The yaw stability, which is not as critical during the cruising phase as during the take-off and landing phase, is also ensured by the rearward displacement of the engines.

### BRIEF DESCRIPTION OF THE DRAWINGS

The attached figures will give a clear understanding as to how the invention can be produced. In these figures, identical references denote similar elements. More particularly:

FIG. 1 is a perspective schematic view of an aeroplane provided with faired engines, in a first configuration;

FIG. 2 is a perspective schematic view of an aeroplane provided with faired engines, in a second configuration;

FIGS. 3A, 3B and 3C schematically illustrate plan views of the aeroplane that is in the configuration of FIG. 1, respectively by top view, by partial front view, and by side view;

FIGS. 4A, 4B and 4C schematically illustrate plan view of the aeroplane that is in the configuration of FIG. 2, respectively by view from above, by partial front view, and by lateral view;

FIGS. 5A and 5B schematically illustrate, in perspective, an engine provided with a displacement mechanism, with the engine, respectively, in a forward position and in an aft position;

FIG. 6 is a perspective schematic view which shows an example of displacement mechanism;

FIG. 7 shows the tail of the aeroplane provided with a propfan engine; and

FIG. 8 is the block diagram of a method for modifying the configuration of an aeroplane.

### DETAILED DESCRIPTION

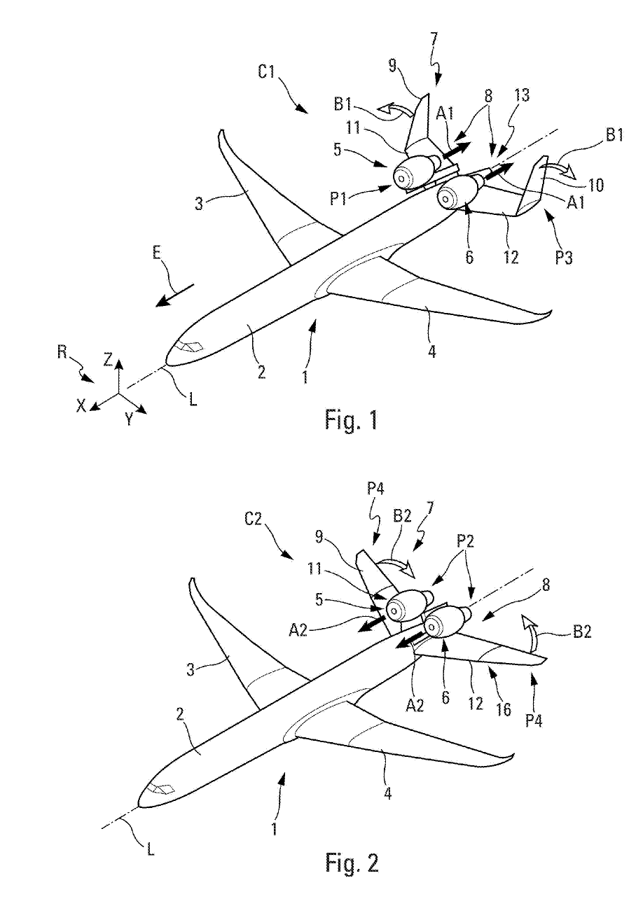

FIGS. 1 and 2 show an aeroplane 1, for example a transport aeroplane, having a longitudinal axis L, which is represented schematically in a particular embodiment.

To facilitate the description, FIG. 1 shows a standard aeroplane reference frame R, comprising three main directions, namely:
a so-called longitudinal direction X, parallel to the longitudinal axis L of the aeroplane 1;
a so-called vertical direction Z, at right angles to the longitudinal direction X, the plane XZ forming a vertical plane of symmetry of the aeroplane 1; and
a so-called lateral direction Y, at right angles to said plane XZ.

FIG. 1 also shows a direction E of flight of the aeroplane 1. In the following description, the terms “forward” and “aft” are defined relative to the direction E (that is to say towards the front or towards the rear of the aeroplane 1). Similarly, the terms “up” and “down” are defined relative to the direction illustrated by the arrow Z (that is to say upwards of or downwards of the aeroplane 1).

This aeroplane 1 comprises, as represented in particular in FIG. 1:
an elongate fuselage 2, of longitudinal axis corresponding to the longitudinal axis L;
two wings 3 and 4 fixed on either side of the fuselage 2;
two engines 5 and 6 arranged on the fuselage 2 on either side of the vertical plane of symmetry XZ of the aeroplane 1. Engine 5, 6, is always understood to mean the assembly formed by the engine members and an associated nacelle if appropriate; and
a rear tail unit 7 comprising a horizontal tail 8 provided with two tail ends 9 and 10.

In the example represented in FIG. 1, the horizontal tail 8 is formed by two tail parts 11 and 12, of generally substantially planar form, which are fixed on either side of the fuselage 2 in proximity to the tail 13 of the aeroplane 1. The tail ends 9 and 10 are arranged, respectively, at the free ends of said tail parts 11 and 12. The tail ends 9 and 10 represent surfaces of generally substantially planar form. The tail parts 11 and 12 and the tail ends 9 and 10 can be provided with standard control surfaces (not represented).

Furthermore, the engines 5 and 6 are arranged on the fuselage at the rear tail unit 7, as specified hereinbelow.

According to an embodiment of the invention, and as specified hereinbelow:
the engines 5 and 6 are mounted on the fuselage 2 so as to be able to be displaced, at least during a flight of the aeroplane 1, substantially parallel to the longitudinal axis L; and
the tail ends 9 and 10 are mounted so as to be able to be pivoted, also at least during a flight of the aeroplane 1, relative to said tail parts 11 and 12 of the horizontal tail 8.

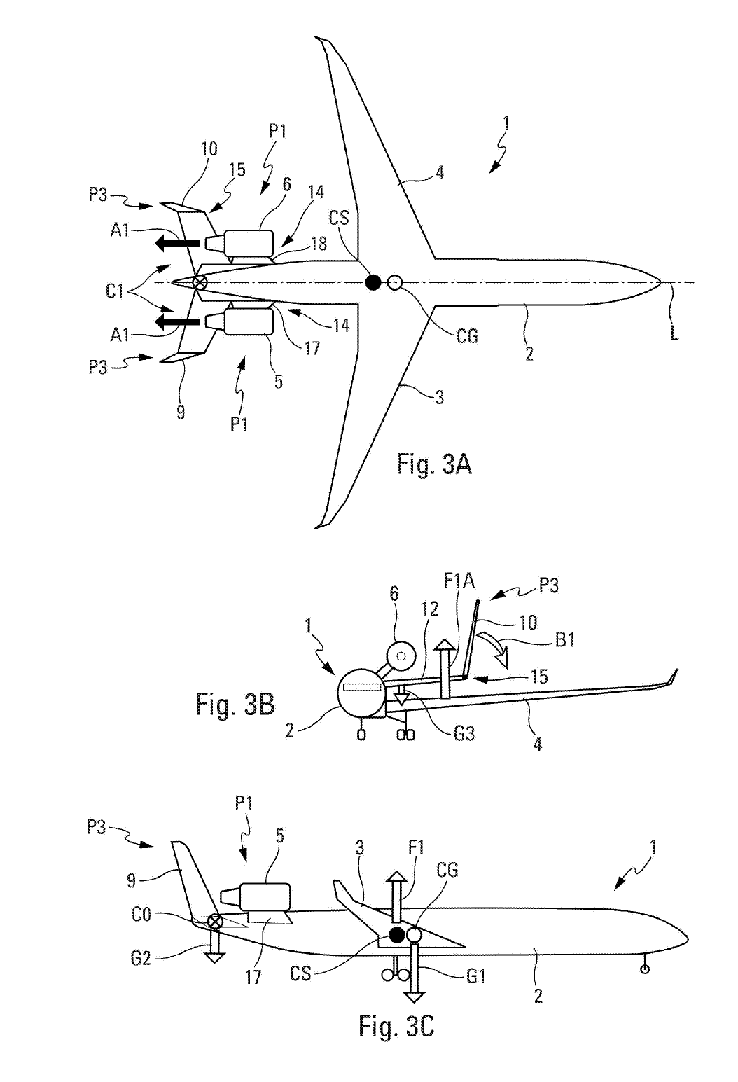

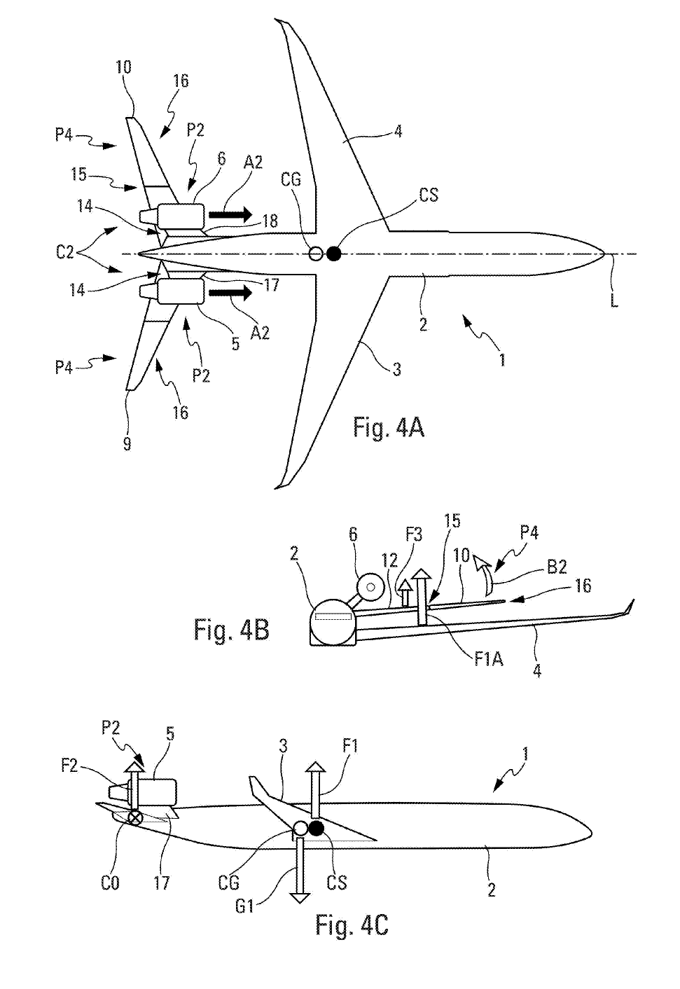

The aeroplane 1 also comprises a displacement mechanism 14 (FIGS. 3A and 4A). This displacement mechanism 14 is capable of being controlled, for example by a command received from a pilot of the aeroplane or by a command received from an automatic piloting system of the aeroplane.

The displacement mechanism 14 is configured to be able to bring, on the fuselage 2, both of the engines 5 and 6, during a flight of the aeroplane 1 and also on the ground, alternately into one or other of the two stable positions P1 and P2.

The so-called forward position P1 is such that the centre of gravity CG of the aeroplane 1 is situated towards the front of the aeroplane 1 relative to the centre of lift CS (representing the point of application of the lift generated by the wings 3 and 4), as represented in FIGS. 3A and 3C. In FIG. 3A, there is an arrow F1 illustrating the lift generated by the wings 3 and 4 of the aeroplane 1, which is directed from the centre of lift CS of the aeroplane 1 upwards. Also shown in this FIG. 3C is an arrow G1 illustrating the weight generated by the mass of the aeroplane 1, which is directed from the centre of gravity CG of the aeroplane 1 downwards.

As for the so-called aft position P2 of the engines 5 and 6, it is positioned towards the rear of the aeroplane 1 relative to the forward position P1, in the direction illustrated by the arrows A1 in FIG. 1. In this position P2, the centre of gravity CG of the aeroplane 1 is situated towards the rear of the aeroplane 1 relative to the centre of lift CS, as represented in FIGS. 4A and 4C.

Moreover, the aeroplane 1 also comprises a pivoting mechanism 15 (FIGS. 3A, 4A and 4B). This pivoting mechanism 15 is capable of being controlled, for example by a command received from a pilot of the aeroplane or by a command received from an automatic piloting system of the aeroplane.

The pivoting mechanism 15 is configured to be able to bring both of the two tail ends 9 and 10, during a flight of the aeroplane 1 and also on the ground, alternately into one or other of the two stable positions P3 and P4.

The so-called folded position P3 is such that the two tail ends 9 and 10 are arranged substantially orthogonally to a general plane formed by said horizontal tail 8 (or its two tail parts 11 and 12), as represented in FIG. 1 and FIGS. 3A to 3C. This general plane can be substantially parallel to a plane XY. In this folded position P3, the two tail ends 9 and 10, of generally planar form, are substantially parallel to the plane XZ. In this folded position P3, the two tail ends 9 and 10 thus form, together, a rear vertical tail and they are capable of fulfilling the standard functions of a vertical tail of an aeroplane. In this folded position P3, the rear tail unit 7 therefore comprises a horizontal tail 8 and a vertical tail formed by the tail ends 9 and 10.

Furthermore, the so-called deployed position P4 is such that the two tail ends 9 and 10 are arranged substantially in the general plane formed by said horizontal tail 8 (or its two unit parts 11 and 12), as represented in FIG. 2 and FIGS. 4A to 4C. In this deployed position P3, the two tail ends 9 and 10 form, with the horizontal tail 8, an augmented horizontal tail surface 16. By virtue of this augmented horizontal tail surface 16, the aeroplane 1 has a global surface that is greater and therefore more efficient for implementing the standard functions of a horizontal aeroplane tail and above all for participating in the lift, as specified hereinbelow.

In the example of FIGS. 1 and 3A to 3C, the aeroplane 1 is in a first configuration C1, in which the engines 5 and 6 are in the forward position P1 and the tail ends 9 and 10 are in the folded position P3.

This configuration C1 of the aeroplane, which is conventional, is used preferably during the take-off and landing phases of the aeroplane 1, as specified hereinbelow. The centre of gravity CG is situated forward of the centre of lift CS, and the horizontal tail 8 exerts a downward force, as illustrated by an arrow G2 in FIG. 3C from a point of application C0 situated at the tail 13 of the aeroplane 1 (or as shown by the arrow G3 for the tail part 12 in FIG. 3B) to keep all of the aeroplane 1 in balance. The balance is obtained by the combination of the different forces illustrated by the arrows G1, G2 and F1. The arrow F1A in FIG. 3B shows the lift generated by the wing 4.

Moreover, in the example of FIGS. 2 and 4A to 4C, the aeroplane 1 is in a second configuration C2, in which the engines 5 and 6 are in the aft position P2 and the tail ends 9 and 10 are in the deployed position P4.

This configuration C2 of the aeroplane 1 is used, preferably, during a cruising flight. The engines 5 and 6 are displaced towards the rear, which results in a displacement towards the rear of the centre of gravity CG, which is then to the rear of the centre of lift CS. The yaw stability, which is not as critical during the cruising phases as in the take-off and landing phases, is also ensured by the rearward displacement of the engines 5 and 6.

The aeroplane can, furthermore, comprise mobile control surfaces (not represented) arranged on the wings 3 and 4 and/or on the rear tail unit 7, to automatically perform an additional yaw correction.

In this configuration C2, the centre of gravity CG is situated to the rear of the centre of lift CS, and the horizontal tail 8 exerts an upward force, as illustrated by an arrow F2 in FIG. 4C from the point of application C0 situated at the tail 13 of the aeroplane 1 (or, as shown by the arrow F3 for the tail part 12 in FIG. 4B) to provide an additional lift, and does so using an enlarged surface (namely said enlarged horizontal tail surface 16).

In the context of the present invention, the displacement mechanism 14 and the pivoting mechanism 15 can be produced in different ways, making it possible to implement the displacement and pivoting functions.

Each of the engines 5 and 6 is arranged on the fuselage 2 of the aeroplane 1 via an associated strut 17, 18, as represented in FIGS. 3A and 4A in particular. In a preferred embodiment, the displacement mechanism 14 is configured to act on the struts 17 and 18.

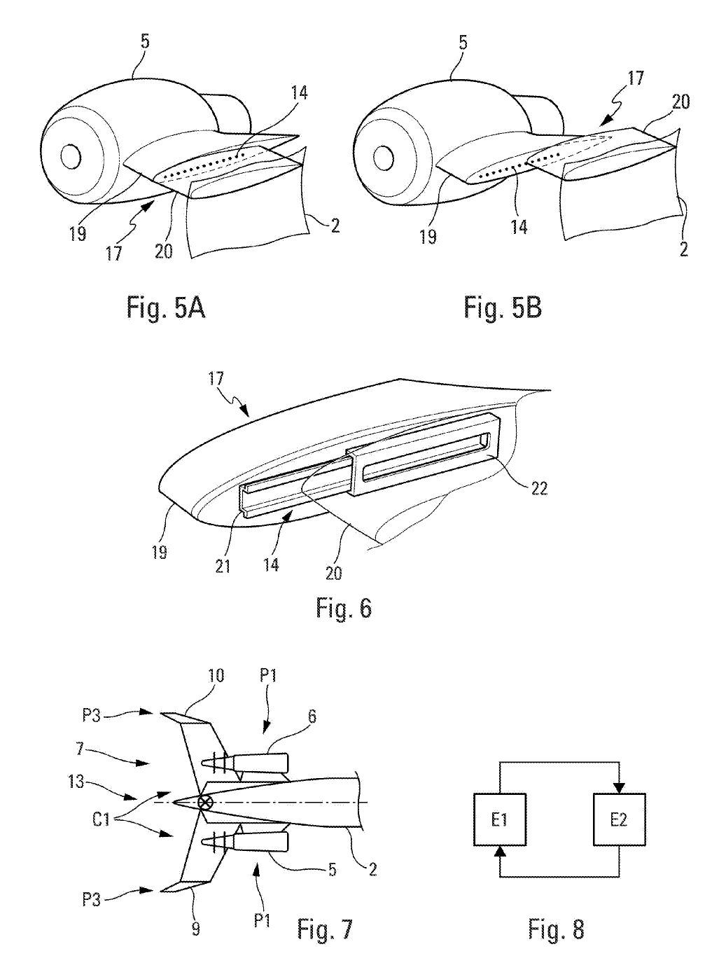

In the example represented schematically in FIGS. 5A and 5B, the strut 17 is formed by two parts 19 and 20, of which one 19 is fixed to the engine 5 and of which the other 20 is fixed to the fuselage 2 of the aeroplane 1.

In this example, the displacement mechanism 14 is incorporated in the strut 17 between the two parts 19 and 20 and makes it possible to generate a displacement of one relative to the other and therefore of the engine 5 relative to the fuselage 2 between an aft position (FIG. 5A) and a forward position (FIG. 5B) of the strut 17 and of the engine 6 with which it is associated.

As an illustration, the displacement mechanism 14 can comprise a sliding system 20, as represented schematically in FIGS. 5A, 5B and 6. In this example, the sliding system 20 comprises a rail 21 fixed onto the part 19 and a guide 22 fixed onto the part 20, which is capable of sliding on this rail 21.

In a variant embodiment (not represented), the displacement mechanism can also comprise an articulation system.

The present invention applies equally to an aeroplane whose engines 5 and 6 are turbojet engines or turbopropeller engines, as represented in the examples of FIGS. 1 to 4C, and to an aeroplane whose engines 5 and 6 are propfan or open rotor engines, with a simple propulsion or a contrarotational propulsion on each strut/engine assembly, as shown schematically by way of illustration in FIG. 7 which represents the tail 13 of an aeroplane 1 in a view similar to that of the tail of the aeroplane of FIG. 3A.

The present invention relates also to a method for modifying the configuration of an aeroplane 1 such as that described above.

This method comprises, as represented in FIG. 8:
a step E1 consisting in bringing the aeroplane 1 into the configuration C1 (FIGS. 1 and 3A to 3C). To do this, this step E1 consists:
   on the one hand, in bringing the engines 5 and 6 into the forward position P1 represented in FIGS. 1 and 3A to 3C, using the displacement mechanism 14, and do so from the aft position P2 represented in FIGS. 2 and 4A to 4C, in the direction illustrated by the arrows A2 in FIGS. 2 and 4A; and
   on the other hand, in bringing the tail ends 9 and 10 into the folded position P3 represented in FIGS. 1 and 3A to 3C, using the pivoting mechanism 15, from the deployed position P4 represented in FIGS. 2 and 4A to 4C, in the direction illustrated by the arrows B2 in FIGS. 2 and 4B;
a step E2 consisting bringing the aeroplane 1 into the configuration C2 (FIGS. 2 and 4A to 4C). To do this, this step E2 consists:
   on the one hand, in bringing the engines 5 and 6 into the aft position P2 represented in FIGS. 2 and 4A to 4C, using the displacement mechanism 14, and doing so from the forward position P1 represented in FIGS. 1 and 3A to 3C, in the direction illustrated by the arrows A1 in FIGS. 1 and 3A; and
   on the other hand, in bringing the tail ends 9 and 10 into the deployed position P4 represented in FIGS. 2 and 4A to 4C, using the pivoting mechanism 15, from the folded position P3 represented in FIGS. 1 and 3A to 3C, in the direction illustrated by the arrows B1 in FIGS. 1 and 3B.

The steps E1 and E2 are implemented, alternately, during a flight of the aeroplane 1. The transition from one to the other of these steps E1 and E2, to change the configuration of the aeroplane 1, can be controlled and performed several times during one and the same flight. The configuration modification control (or control of activation of one or other of the steps E1 and E2), can be generated by a pilot of the aeroplane or by an automatic piloting system of the aeroplane.

The step E1 is implemented, at least, during a take-off phase of the aeroplane and/or during a landing phase of the aeroplane, and the step E1 is implemented, at least, during a cruising flight phase of the aeroplane.

By changing the configuration of the aeroplane and the position of the centre of gravity during the flight, it is thus possible to augment the aerodynamic efficiency of the aeroplane 1, and to reduce the fuel consumption. Furthermore, the aeroplane 1, as described above, is able, when it is in the configuration C2, to fly at a higher altitude than the usual maximum cruising flight altitudes.

The aeroplane 1, as described above, offers many other advantages.

In particular, through the capacity to pivot the tail parts 9 and 10:
the lift surface of the aeroplane 1 can be augmented, for example by approximately 10%, with a low mass penalty due to the displacement and pivoting systems 14 and 15;
a reduction of fuel consumption is obtained. In cruising flight, the rear tail unit 7 in fact generates, using the tail plane parts 11 and 12 and the tail ends 9 and 10, a lift force, and the aeroplane can fly at a higher altitude;
the surface augmentation through the deployment of the tail parts 9 and 10, makes it possible to fly at a higher altitude, without increasing power and without increasing the surface of the main wing formed by the wings 3 and 4 (and therefore without increasing mass);
the tail parts 9 and 10 (forming, in folded position, a rear vertical tail) become a lift surface when they are deployed during the cruising flight phase;
the complete rear horizontal plane 7 becoming a lift surface and not a surface applying a downward force can be a laminar surface.

The aeroplane 1, as described above, also offers the following advantages:
the rearward displacement of the engines increases their distance relative to the cabin of the aeroplane, and thus reduces the noise in the cabin;
during the take-off and approach phases, the tail ends 9 and 10 in vertical position act as antinoise shields for the noise generated by the outlets of the engines 5 and 6;
for the engines of “open rotor” type, the rearward displacement of the engines for the cruising flight significantly reduces the vibrations and the fatigue generated;
if, during a cruising flight, a blade were to be detached from the fan of an engine or from the propeller of an engine, it would not have impact on vital zones of the fuselage, which makes it possible to increase the overall safety of the aeroplane.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aeroplane comprising:
at least a fuselage;
two wings;
a rear tail unit comprising a horizontal tail provided with two tail ends; and
at least two engines arranged on the fuselage on either side of a vertical plane of symmetry of the aeroplane, said aeroplane having a longitudinal axis,
wherein said engines are mounted so as to be able to be displaced, at least in flight, on said fuselage, substantially parallel to the longitudinal axis, and
wherein said tail ends are mounted so as to be able to be pivoted, at least in flight, relative to said horizontal tail.

2. The aeroplane according to claim 1, said aeroplane having a centre of gravity and a centre of lift,
further comprises at least one displacement mechanism configured to be controlled and to be able to bring each of said engines, at least in flight, alternately into one or other of the following two stable positions, on the fuselage:
a forward position, in which the centre of gravity of the aeroplane is situated towards the front of the aeroplane relative to the centre of lift; and
a aft position, positioned towards the rear of the aeroplane relative to said forward position and in which the centre of gravity of the aeroplane is situated towards the rear of the aeroplane relative to the centre of lift.

3. The aeroplane according to claim 1, further comprising at least one pivoting mechanism configured to be controlled and to be able to bring each of the two tail ends, at least in flight, alternately into one or other of the following two stable positions:
a first, folded position, in which the two tail ends are arranged substantially orthogonally to a general plane of said horizontal tail so as to form a vertical tail; and
a second, deployed position, in which the two tail ends are arranged substantially in the general plane of said horizontal tail so as to form, with the horizontal tail, an augmented horizontal tail surface.

4. The aeroplane according to claim 2, wherein the displacement mechanism comprises a sliding system.

5. The aeroplane according to claim 2, wherein the displacement mechanism comprises an articulation system.

6. The aeroplane according to claim 1, further comprising mobile control surfaces configured to act on the yaw of the aeroplane.

7. The aeroplane according to claim 1, wherein said engines are jet engines or turbopropeller engines.

8. The aeroplane according to claim 1, wherein said engines are propfan or open rotor engines.

9. A method for modifying a configuration of an aeroplane in flight, said aeroplane comprising at least a fuselage, two wings, a rear tail unit comprising a horizontal tail provided with two tail ends, and at least two engines arranged on the fuselage on either side of a vertical plane of symmetry of the aeroplane, said engines being mounted so as to be able to be displaced on said fuselage, substantially parallel to a longitudinal axis of the aeroplane, and said tail ends being mounted so as to be able to be pivoted relative to said horizontal tail,
the method comprising:
at least a first step including bringing said engines into a forward position and in bringing said tail ends into a folded position in which said tail ends are arranged substantially orthogonally to a general plane of said horizontal tail; and
at least a second step including bringing said engines into a aft position, displaced towards the rear of the aeroplane relative to said forward position and in bringing said tail ends into a deployed position in which said tail ends are arranged substantially in the general plane of said horizontal tail,
said first and second steps being implemented alternately at least during a flight of the aeroplane.

10. The method according to claim 9, wherein said first step is implemented, at least, during a take-off phase of the aeroplane and/or during a landing phase of the aeroplane, and
wherein said second step is implemented, at least, during a cruising flight phase of the aeroplane.
